(19) United States
(12) Patent Application Publication
(10) Pub. No.: US 2018/0121903 A1
(43) Pub. Date: May 3, 2018

(54) SMART TRANSPORT SOLUTION

(71) Applicant: Sekurus International, Inc., Mississauga (CA)

(72) Inventor: Basel Al Salah, Mississauga (CA)

(73) Assignee: Sekurus International Inc., Mississauga (CA)

(21) Appl. No.: 15/699,649

(22) Filed: Sep. 8, 2017

Related U.S. Application Data
(63) Continuation-in-part of application No. 15/457,767, filed on Mar. 13, 2017.
(60) Provisional application No. 62/306,717, filed on Mar. 11, 2016.

(51) Int. Cl. G06Q 20/24; G06Q 10/00; G07C 5/02

(52) U.S. Cl. CPC G06Q 20/24; B60R 25/00; G07C 5/02; G06Q 10/20

(57) ABSTRACT

Provided is a repayment system including devices for and methods of interrupting a critical system of equipment in response to unauthorized use, or failure to maintain the equipment or make timely payments. The following invention disclosure is generally concerned with electronic systems for the management, monitoring and disabling of equipment in response to a failure to perform timely maintenance and timely payments on a corresponding loan, lease or rental by the integration of: GPS+RFID vehicle security+Driver Identification+in vehicle Diagnostics integrated into a multi-vertical management system.

### CROSS REFERENCE TO RELATED APPLICATIONS

The present application is a Continuation-In-Part of U.S. Ser. No. 15/457,767, filed on Mar. 13, 2017, and claims priority to U.S. Provisional Application 62/306,717, filed Mar. 11, 2016, both entitled “SMART TRANSPORT SOLUTION”, the disclosures of which are hereby incorporated by reference in their entirety.

### BACKGROUND OF THE INVENTION

### Field

The following invention disclosure is generally concerned with electronic systems for the management, monitoring and disabling of equipment in response to a failure to perform timely maintenance and timely payments on a corresponding loan, lease or rental as a Smart Transport. Solution by the integration of: GPS+RFID vehicle security+Driver Identification+in vehicle Diagnostics integrated in to a multi vertical management system, linked to CRM (Customer Relationship System) management solution of an IoT (Internet of Things) and a Machine to Machine (M2M) platform.

### Related Art

Systems have been introduced to display an error in an automobile or interrupt the ignition system of an automobile on a regular, timed interval. To clear the displayed error or re-enable the vehicle/equipment, a user is generally required to return to a center for maintenance or to make a payment, and have an agent reset the alert or interrupt mechanism for a renewed timed interval. The system can only be reset by an authorized agent as it requires special equipment or a key held in escrow at the management center. While the system is effective in encouraging customers to maintain and repay their auto loans in a timely fashion, it has extreme overhead considerations. The system requires a customer to travel to a maintenance or a management center each service or payment period of the loan. Of course, this prevents the user from taking extended travel without first making an advanced payment. In addition, a user must arrive at the maintenance or management center during the hours in which it is open. Still further, a user must wait to receive the attention of the agent. As these problems pose considerable inconvenience, these systems suffer from limited utility and acceptance. It is desirable to automate the reset process so a user is not required to travel to a single maintenance or management center to perform the needed maintenance as long as the maintenance is performed in an authorized center and the information is passed to the contract management center.

As a part of managing the value of an asset that is owned or co-owned (due to a loan, lease or rental) companies need to manage the up-keeping of their assets thereby insuring not only that they receive timely payment, but that the equipment remains in good condition while they hold an interest in the asset. Monthly payments to utility companies are made with very high reliability. This is partly due to the threat of service cut-off. Failure to pay a phone bill will result in loss of telephone services. Thus, phone bills are paid regularly because failure to do so has immediate and tangible results. Periodic maintenance and payments on an automobile loan are not likely to be as regular. Although a vehicle may be repossessed, the process is expensive and complex and thus the threat of doing so is less immediate than telephone service cut-off. The asset could also be in a poor condition due to lack of maintenance or misuse. To encourage maintenance and reliable loan re-payments, it is desirable to have a “service” that will monitor the condition of the equipment and cut-off use of the equipment based on predefined conditions within an agreement.

Techniques have been discovered which provide varied uses of automobile ignition or starter interruption systems, particularly with respect to those which may be reset with minimal intrusion and burden upon a user's freedom. While such systems and inventions of the art are designed to achieve particular goals and objectives, some of those being no less than remarkable, these inventions have limitations which prevent their use. These prior art ideas are not used and cannot be used to realize the advantages and objectives of the present invention.

### OBJECTIVES OF THE INVENTION

It is a primary object of the invention to provide systems to improve maintenance of equipment/vehicles and insure timely repayment of a loan.

It is an object of the invention to provide a system which can be operated without having to bring equipment to a predetermined location.

It is an object of the invention to provide systems to enable and disable equipment in response to maintenance and receipt of loan payments.

It is a further object to provide systems which interrupt a critical system of equipment in response to a failure to receive a command in due time.

### SUMMARY OF THE INVENTION

In accordance with the foregoing objectives, provided is a repayment system including devices for and methods of interrupting a critical system of equipment in response to unauthorized use, failure to maintain or make timely payments.

A critical system interruption circuit in communication with a logic processing unit operates to disable and enable equipment in response to maintenance or loan payments being timely made. When a user makes the needed maintenance or payment on an outstanding loan, usually a loan related to the equipment, a logic processor is notified of the action. The logic processor drives a switch coupled to a critical system interruption means to enable or disable the equipment in accordance with payment receipt. Once the equipment has under gone maintenance, a unit is connected to the equipment resetting the maintenance monitoring system to the next cycle, whether time of use or distance of use, and clearing any error code that may be there prior to maintenance. Thus, the present system cannot only insure timely payment of any loan, it can also insure that the asset is maintained. This is a benefit to the driver or operator of the car or equipment, as well as the owner of the car or equipment.

In some preferred versions, when a user makes a payment on an outstanding car loan, a command is released to the user. The user then operates a user-operator interface connected to a logic processing unit to convey the command. Once the command is verified, the logic processing unit manipulates the automobile starter circuit to enable the vehicle.

In one example, a starter interruption circuit is arranged to disable and enable an automobile in response to loan payments being timely made. When a user makes a loan payment, the command is released to the user from a payment center. The user operates a user interface to convey the command to a logic processing unit. Upon verification, the logic processing unit operates an interruption circuit to enable the automobile for further use. Thus it becomes possible to interrupt service of equipment in response to failure to follow the terms of an agreements associated with the equipment.

The apparatus of the invention generally includes a critical system interruption circuit operable for enabling and disabling a critical system of certain equipment; a logic processing unit having a reference command generation and storage facility and comparator; and in some versions, a user interface operable for receiving a command from a user and conveying that command to the logic processing unit.

Methods of the invention may be summarized as those which include the steps: computing a service contract or payment due deadline, generating a reference command which corresponds to the deadline, receiving a command at a logic processing unit, comparing the received command to the reference command, disabling a critical system if a correct command is not received before a present time exceeds a maintenance and/or a payment due deadline; enabling a critical system on receipt of a correct command; and computing subsequent maintenance and/or payment due deadlines and generating a reference command which corresponds to the subsequent deadline.

In some preferred uses of systems of the invention, a user who purchases a car from a dealer agrees to have the system installed on the purchased automobile to protect the lender asset and insure the payments on an outstanding loan. On initiation, parameters which relate to maintenance and loan terms, for example maintenance date or driving distance and total number of payments and payment interval, are loaded into a system memory from a server unit. The logic processing unit computes a deadline time which corresponds to a maintenance due date and up keeping of the asset and time for receipt of a payment. When a user follows terms of the agreement, the system sends a confirmation via a multi delivery communication channel: mobile application, Web, direct communication with the system that releases a predetermined alpha-numeric command to the user. The user then can send the command via a wireless interface of his mobile application user interface so that the logic processing unit can process the command for verification. If the command matches a reference command stored or generated within the device, then the logic processing unit puts the starter interruption circuit in a state which enables the vehicle's ignition system.

A user who fails to carry out the terms of an agreement being linked to maintenance or make a payment will not receive the command necessary to ‘unlock’ the system. If the user fails to enter the proper command by the time the deadline passes, the vehicle is put into a disabled state by way of interruption of the starter until the maintenance or payment is made. Thus the logic processing unit is provided an indication that maintenance or timely payment was made via receipt of a correct command.

The invention thus stands in contrast to methods and devices known. The present invention includes a critical system interruption mechanism which can be operated without the user returning to the maintenance or a payment center. Systems of the art require returning to the maintenance or payment center.

The present system and method can be used in connection with cars, or any other equipment that might be rented, or subject to a loan. A car or any equipment requiring maintenance can also be monitored by the present system and method by the owner/lender to insure that the car or equipment is properly maintained. The ultimate owner could also use the present system as a means to insure continued upkeep of one's equipment.

Any car can be the subject of the present system and method. As well, any equipment such as appliances, construction equipment, furniture, or housewares that are rented, can also be the subject of the present system.

The present system, devices and methods also provides an improved platform from which both a lender and the customer can gain certain advantages. Important data can be recorded, stored which can enable the provider, e.g., the lender, to better protect its assets. The same data can also aid the customer in managing its assets and obligation. The data can also be used by the customer in future transactions, providing important information to facilitate those transactions.

A better understanding can be had with reference to the detailed description of preferred embodiments and with reference to the appended drawings. These embodiments represent particular ways to realize the invention and are not inclusive of all ways possible. Therefore, there may exist embodiments that do not deviate from the spirit and scope of this disclosure as set forth by the claims, but do not appear here as specific examples. It will be appreciated that a great plurality of alternative versions are possible.

### BRIEF DESCRIPTION OF THE DRAWINGS

FIG. 1 is a schematic drawing of the overview of the full process of communication and connectivity with a vehicle, and the wireless appliance to a central control system according to an embodiment of the present invention.

FIG. 2 is a schematic drawing of a wireless appliance according to an embodiment of the present invention featuring an integrated with maintenance/Payment enforcement linked to a contract processing.

FIG. 3 is a schematic drawing of a wireless appliance according to an embodiment of the present invention featuring integration with a Fleet Management system linked to a contract.

FIG. 4 is a schematic drawing of a wireless relay and appliance according to an embodiment of the present invention featuring an integrated back office management application Communication Flow.

FIG. 5 is a schematic drawing of a wireless appliance according to an embodiment of the present invention featuring an integrated command communication with the unit and the process of disablement or enablement

FIG. 6 is a schematic drawing of the processing units within the appliance and wireless appliances within the Equipment/Vehicle.

FIG. 7 is a schematic drawing of the processing units within the appliance and wireless appliances relating to the reporting of loss of communication between wireless installed components due to tamper or disconnection of main power supply to the management center.

FIG. 8 is a schematic drawing of processing units within the appliance and wireless appliances, and the reporting of loss of communication between wireless installed components due to tamper or disconnection of main power supply to the management center linked to an emergency alert.

FIG. 9 is a schematic drawing of processing units within the appliance and wireless appliances and sending a disablement or enablement report via a multi communication protocol and reporting the action to the management center.

FIG. 10 is a schematic drawing of processing units to manage a preauthorized identification system linked to a user list, their driving profile having been predefined within the wireless appliances and stored in the central application.

FIG. 11 is a schematic drawing of the processing of data from a unit and processing the information via a multi communication channel that is user defined in the case of Bluetooth connectivity with a mobile device with a mobile application, the data is sent to the mobile device that will transmit to the management center (A); and also of processing of data from the unit and processing the information via a multi communication channel that is user defined in the case of there being no Bluetooth connectivity with a mobile device with a mobile application. The wireless transmitter within the appliance will start a data communication and send the relevant data to the management center (B).

FIG. 12 is a schematic drawing of processing units within the appliance and wireless Multi CUT-OFF that will go into effect by receiving a command from the management center to disable/enable the circuit, or cut-off in the case of tamper or unauthorized use of the Equipment/Vehicle.

FIG. 13 is a schematic drawing of a wireless appliance according to an embodiment of the present invention featuring integrated antennae and custom ASICs for power management, OBD-II communication, GPS, and a wireless transmitter.

FIG. 14 is a schematic drawing of a vehicle featuring a wireless appliance that communicates with a GPS, a wireless communication network, and an Internet-accessible web page according to an embodiment of the present invention.

FIG. 15 is a schematic drawing of processing units within the appliance and wireless relay in relation to tamper.

FIG. 16 is a schematic drawing of processing units within the appliance and wireless relay in relation to tamper reporting to the control center.

FIG. 17 is a schematic drawing of processing units within the appliance Full Flow and communication with the control center and management applications.

FIG. 18 is a screen capture of a web page that displays a vehicle's diagnostic data monitored by the wireless appliance according to an embodiment of the present invention.

FIG. 19 is a screen capture of a Mobile application page that displays a vehicle's diagnostic data monitored by the wireless appliance according to an embodiment of the present invention, and a screen capture of a Mobile application page that displays a vehicle's information for management of vehicle commands or enable/disable of cutoff immobilizer.

FIG. 20 is a schematic showing how the present system can be used as a vehicle maintenance one-step solution.

FIG. 21 schematically shows how the present system can make more efficient the diagnosis and repair of an automobile.

FIG. 22 is a schematic showing how the platform offered by the present system can benefit the provider as well as the customer.

FIG. 23 shows the various ways the platform offered can benefit the customer.

FIG. 24 schematically depicts the functional architecture possible in using the present system and methods.

FIG. 25 schematically depicts the authentication authorization sharing possible in using the present system and methods.

FIG. 26 illustrates the feature rich administration module that enables user and system management.

FIG. 27 illustrates the process design of the system connecting the users and information.

### DETAILED DESCRIPTION

Equipment and vehicles are becoming more and more sophisticated as we have entered into the age of the IoT (“Internet of Things”) where everything is connected. It is not only important for the service provider to receive their payment in a timely manner, but to also insure that their assets are well maintained. A relationship must be built with clients by aggregating data from various sources into easy-to-comprehend reports and alerts that helps subscribers understand their vehicles' performance and one that helps monitor diagnostic trouble codes in the vehicle. Estimates of cost of repair can be provided. While similar systems are known to be available in luxury vehicles, the present invention brings the functionality to entry level equipment/vehicles and light trucks.

Embodiments of the present invention relate to a wireless appliance for monitoring equipment. In one embodiment, the appliance includes: (1) a microprocessor; (2) a vehicle-communication circuit; (3) a GPS module; (4) a multi-protocol wireless transmitter; (5) an in vehicle RF received/transmitter; (6) power management cell; and (7) a multi-wireless circuit cut-off linked to ignition or starter interruption system which may be set to take affect at a predefined speed. The wireless transmitter receives and transmits location-based data generated by the GPS module and diagnostic data collected by the vehicle-communication circuit. The vehicle-communication circuit can be integrated into a multi ASIC that includes modules for managing different vehicle-communication protocols, such as, for example, SAE J1850 PWM, SAE J1850 VPWM, ISO 9141-2, CAN, Keyword 2000, ISO 14230-4 KWP, ISO 15765-4 CAN, SAE J1939 CAN, and J1705.

Some vehicles include global positioning systems (‘GPSs’). A conventional GPS features an antenna that receives signals from orbiting satellites and a chipset that processes these signals to calculate a GPS ‘fix’. The fix features data such as a vehicle's latitude, longitude, altitude, heading, and velocity. The fix describes the vehicle's location with a typical accuracy of about 10 meters or better.

Light-duty automobiles and trucks beginning with model year 1996 include on-board diagnostic (OBD-II) systems as mandated by the Environmental Protection Agency (EPA). OBD-II systems monitor the vehicle's electrical, mechanical, and emissions systems and generate data that are processed by a vehicle's engine control unit (ECU) to detect malfunctions or deterioration in the vehicle's performance. The data typically include parameters such as vehicle speed (VSS), engine speed (RPM), engine load (LOAD), and mass air flow (MAF). The ECU can also generate diagnostic trouble codes (DTCs), which are 5-digit codes (e.g., ‘P0001’) indicating electrical/mechanical problems with the vehicle. Most vehicles manufactured after 1996 include a standardized, serial 16-point connector, referred to herein as an ‘OBD-II connector’ that makes these data available. The OBD-II connector serially communicates with the vehicle's ECU and typically lies underneath the vehicle's dashboard.

Conventional GPSs can be combined with systems for collecting the vehicle's OBD-II diagnostic data to form ‘telematics’ systems. Such telematics systems typically include a microprocessor that runs firmware that controls separate circuits that communicate with different vehicle makes (e.g., Ford, GM, Toyota) to collect OBD-II data; a GPS module; and (3) a separate wireless transmitter module that transmits the GPS and OBD-II data.

The utility model discloses an OBDII code reader that is user configurable to use wireless telecommunication network channel or Bluetooth. The OBD II code reader comprises a shell, a base, an upper circuit board, a connector and a lower circuit board, wherein the shell is adaptively connected with the base; the lower circuit board is mounted in the base; the upper circuit board is arranged above the lower circuit board; the upper circuit board is connected with the lower circuit board by virtue of the connector; a power supply from the vehicle OBDII and a backup battery the OBDII interface is formed in the bottom of the base; the OBDII driving unit is connected with the OBD II interface; a Bluetooth unit is arranged on the upper circuit board; a power supply unit and the OBDII driving unit are respectively connected with the Bluetooth unit by virtue of the connector. The RF unit connects to a wireless relay that is connected to the ignition interruption circuit the same RF communicates with and identifier that identifies a driver or drivers allowing to use the vehicle and reports the ID to a central or local application the OBDII code reader is capable of reading vehicle failure data in timely, simple and reliable manner along with driver behavior patterns for optimum performance using a structure process and is low in cost.

Provided below is a road map of how the GPS, RFID, driver identification and Bluetooth diagnostics can be integrated:

The integration of: GPS+RFID vehicle security+Driver Identification+Bluetooth Diagnostics.

1. Plug & play design with OBD-II connector, compatible with vehicles with OBD-II connector and supports CAN-BUS communication protocols;
2. It is the integration of GPS, AGPS (Locate, track and trace)+RFID vehicle security +Driver Identification+Bluetooth Diagnostics;
3. Arm/disarm via a multi communication protocols SMS/phone call/smart mobile app or 2.4G RFID tag automatically (TCP/IP, UDP, SS7, USSD;
4. Geo location of physical address the latitude, longitude, speed, direction & odometer etc.;
5. Movement Alert, Over-speed alarm, Geo-fence alarm;
6. Ignition ON Alert, power failure Alert, vibration Alert;
7. Anti-tamper alert. Once the device is disconnected, it will trigger an Alert to the control center and is a wires immobilizer (relay is installed it will trigger a tamper and disrupt the circuit);
8. Multi wireless immobilizer relay installation (up to six relay can be installed with one main unit to disrupt the circuit)
9. Built-in shock sensor for power saving & triggering vibration Alert;
10. Voice Monitoring; (optional);
11. Supports 2.4G long-range RFID function (optional);
12. Keyless RFID vehicle security function (optional);
13. Accurate odometer & speed reading directly via CAN-BUS;
14. Data logger for offline GPS waypoint;
15. Remote Vehicle diagnostic & clear the error code;
16. Built-in rechargeable backup battery; when the vehicle battery is cut off or damaged, the built-in backup battery will send an alert of the main power loss (system will send out power failure alert immediately) and can be used for and emergency checks.
17. The Vehicle Location can be determined using global positioning satellites (GPS) or by triangulation using base stations in mobile radio systems (AGPS).
18. Multi vehicle parking lot lock down
19. Remote diagnostics function. Transmission of the following data via blue-tooth or GPRS network:
A. Battery's voltage, RPM, speed, TAP throttle opening, engine load, coolant temperature, fuel consumption, odometer, error code & times, acceleration times & deceleration times;
B. Driver behavior data: ignition time, total driving time, total idling time, average engine hot-start time, average speed, history high speed, history RPM, total acceleration times & total deceleration times.

### Insurance

The platform offered by the present system can be used beneficially by both the provider, e.g., lender, and the customer. For example, use can be made with regard to insurance.

UBI (User Based Insurance) became a popular term for insurance companies regarding the use of devices or a mobile app that are linked to their own company in which the driver behavior intelligence is linked with the company insuring the driver. There is no access by the user to such data, however, allowing the consumer to share their driving behavior with other companies.

The present system delivers on the promise of being the premier, most complete UBI solution, offering a one stop shop for an insurer's UBI needs. No additional suppliers or multiple partners to work with and, most importantly, it offers the end user the library of sending their driver behavior intelligence to multiple insurance companies without the need to start all over when moving insurance companies.

### Key Differentiators

One-stop shop for all UBI program needs: UBI Intelligence offers insurers a single source provider for all their UBI program needs, including hardware, logistics, support, secure data warehousing, data analytics, driver portals and more. No need to deal with multiple suppliers and partners.

The present system is fully customizable without sacrificing speed to market: UBI Intelligence provides the best of both worlds:

1) A turnkey approach to improve time-to-market while also

2) Being customizable to program requirements.

Value-added services for the consumer safety and UBI Intelligence is powered by the present connected car platform—providing insurers and their customers the ability to roll-out future services easy to deliver to current customers. Examples of value-added services include: infotainment, roadside assistance, vehicle health and more. UBI Intelligence provides solution options so customers and insurers can create targeted programs for specific audiences and geographies. Driver behavior analytics can be available allowing the consumer to adjust their access to a team of subject matter experts with the experience and best practices developed by working with numerous insurers around the globe.

Insurers can now boost profitability by tailoring their program strategy to each customer and product according to the driver behavior data sent by the client requesting a UBI discount. Based on the data provided a wide range of solution options for all types of program and segmentation needs can be designed and offered. Just like the consumer credit report and rating, UBI is linked to good driver behavior data and such data should be available to the client to share with multiple providers. This allows the customer as an auto policyholder the benefit of insurance discounts along with value-added services, all while encouraging better driver behavior which results in fewer claims.

For the insurance company, the present platform allows the company to differentiate and enrich the offering to take advantage of UBI data while providing a fleet management product that addresses real fleet business needs, including cost savings. With an easy-to-use solution that provides fleet savings and improved driving behavior, both the insurance company and the commercial fleet users win.

The present platform can include variable-based programs, track mileage, time of day, driver behavior, program length and more. Actual vehicle usage and vehicle inactivity can be tracked. The insurance companies can design programs and target segmented groups such as young drivers, mature drivers and more.

### Assets Monitoring

As the vehicle is the asset of the finance company, in which they hold a security interest, it is important for them to manage and monitor that asset.

The present platform offered by the systems of the present invention will help the finance companies define a range of solution areas that clearly address the customers' needs. The present system will make it easier for a finance company to position its asset management-based capabilities to customers looking for a specific solution. In a competitive world it is vital to separate oneself from the pack. Differentiate one's business by demonstrating proven experience. The present platform gives one the opportunity to showcase advanced skills to customers while providing the organization much-needed visibility in a crowded marketplace. The organization can have access to a diverse array of exclusive benefits. From a unique competency brand to a dedicated online resource center providing premier content and tools, these targeted benefits support a core business focus and help improve market impact and reach. A network of business partners can also be forged using the present platform through enhanced partner-to-partner connections.

Empowered by the present platform, enhanced multi-carrier service offerings can be made. One can handle customer service & billing, optimize network utilization while delivering proactive asset management, tracking of indications and uses, and overall simplifying the often complex connected anywhere, anytime world. The delivery of information from thousands of devices across an enterprise can be achieved. Whether through a cloud computing model, connectivity designed for mobile computing, or the most empowered enterprise, the present platform delivers the support services that bring it all together. Connecting non-networked devices, delivering the value of knowing where assets are and what they are doing, or simply improving performance through machine-to-machine (M2M) interaction, the present platform can tie the world's innovations together. For example, the present devices are capable of detecting sudden speed or course changes, configurable, for example, in four speed ranges. When such an event occurs, the unit can create an event or series of events as frequent as 1 per second.

Driver identification can be enhanced. Each driver is equipped with an individual programmable key, enabling driver identification and full driver activity logging in the control center database. The unit can be configured to activate a reminder signal for drivers who forget to identify themselves.

Real time tracking can be achieved for continuous tracking of the vehicle. The system transmits constant location and status information to the control center at predefined elapsed time or driving distance intervals.

Real time alerts can be made a reality in the event that any of the vehicle's security inputs are activated. The unit immediately transmits a real time alert to the control center. Each alert transmission includes detailed location information, transmission reason, I/O status and power voltage indication (main and back-up).

Status requests can be made at any time. The operator can request an immediate status and location report from the unit.

Online event reporting can be realized when GPRS coverage is available. The unit can continuously transmit vehicle status events at user-defined intervals. Each transmission includes a transmission reason (event type), vehicle ID, driver ID, time stamp, detailed location information, speed, heading, accumulated mileage, I/O status, battery voltage, and more.

Events can be controlled. For example, the event can comprise ignition on/off, overspeed start/end, idle speed, elapsed time, elapsed driving distance, distress button activation, navigation start/stop, input sensor activation (such as door opened) and more. All event types can be remotely (OTA) or locally configured. When the vehicle is idle for extended time periods, the system can be configured to transmit a status message at predefined time intervals, for a keep-alive check.

When cellular coverage is unreliable or absent, the unit's non-volatile memory can store up at least 2256 complete time stamped events. This data can be transmitted immediately when coverage is resumed. Logged events are stored for an unlimited duration, even in case of failure of both primary and back-up power sources.

The system can also be programmed such that in case the vehicle violates a designated perimeter or enters a predefined prohibited zone, or if it deviates from a fixed route within a preset timeframe, an immediate alert is triggered. These features offer substantial reduction of communication costs, by allowing a lower resolution of transmissions. Options are OTA configurable.

The unit's exceptionally low current consumption (1 mAmp in hibernation mode) extends battery life and significantly expands its operation span. The present unit provides GPS location output, which can be connected to an in-car navigation device, or a PDA. Such devices can also be used for exchanging text messages with central control. External devices such as a terminal, vehicle computer, built-in intelligent alarm system, etc. can be connected to the unit via its serial data interface (standard RS232, 9,600 BPS).

Due to the present platform, devices can be provisioned, monitored and reconfigured remotely, most anywhere in the world. Coupled with the platform's architecture, a flexible, modular architecture for fast wireless asset management, solutions development and deployment can be delivered. The architectures coupled with a unique ability to understand device and network interaction, accelerates ability to integrate many high-value features quickly and reliably, bringing one ever closer to a connected, anywhere, anytime enterprise.

### Dealer Inventory

The use of GPS technology with the present system helps increase profit-per-vehicle. The system allows dealers to offer customers a high-tech, high-value product in their finance department. When car buyers purchase this system, they will appreciate the safety it affords their family along with the security only a state-of-the-art stolen vehicle recovery system can offer. Consumers can locate their vehicle right from their smartphone and receive low battery, speed and perimeter alerts via text message or email.

According to a National Study, 22% is the number of dealers having a vehicle stolen off their dealership in the past year. 30% of dealers have experienced an inability to locate a vehicle so that their customer can take a test drive. 80% of dealers have encountered a dead battery when attempting to take a customer on a test drive. When the present system is installed in the cars on a dealer's lot, the software platform allows salesmen and other dealership personnel the ability to instantly locate vehicles by stock number or VIN, right from their smartphone. In addition to providing efficacy-creating analytical tools and reports, and with a simplified OBDII plug and play, a device install can be completed in minutes. Reading all vehicle data including VIN and mileage can be done with few clicks. Disable all vehicles on a preset schedule or individually at the end of business day, and enable all vehicles a preset schedule the next day. The use of any vehicle can be limited by using the present devices. Furthermore, RFID technology and Geo-fences can be created to form a virtual wall around a dealership, with the system sending an instant alert if a car is taken beyond defined boundaries. If it has been stolen and the thieves are on the run, real-time tracking makes it possible for the dealer's staff to tell the police the vehicle location.

Low battery and speeding alerts are possible. Vehicles can be located by stock number, VIN, make, or model. The system is an active device and the system is constantly monitoring the vehicle. Owners are notified the moment the vehicle is stolen. With other products, it might be hours later before one realizes they are the victim of a theft. In one embodiment, the system monitors the vehicle's electrical, mechanical, and emissions systems and generate data that are processed by a vehicle's engine control unit (ECU) to detect malfunctions or deterioration in the vehicle's performance. Appropriate responses can then be made. The responses can be programmed or initiated.

### Personal Safety

Another advantage of the present platform is that the system provides vehicle owners with the ability to locate and track their vehicle any time, and the capacity to monitor driving behavior. This is an ideal product for families with teen drivers. Vehicle owners can secure the safety of their vehicle and protect young and inexperienced drivers. It works by using GPS and cellular technology to provide real-time vehicle tracking and monitoring data. GPS satellites send location and monitoring data to the vehicle-installed hardware. The hardware combines location information with vehicle data such as location and speed. The data is then sent over a wireless network to the operations center. This data is always available directly to the vehicle owner via the internet. Authorized users on the account have 24/7 access to the vehicle's location and multiple monitoring and reporting functions. This offers vehicle owners the ability to remotely unlock the door if keys have been locked inside, pre-set speed limits and geographic boundaries (safety zones' for teen drivers), receive alerts via email or text message if pre-set speed limits and boundaries are exceeded, pinpoint a parked vehicle's location in the event that the driver cannot find their car, and track and pinpoint the exact location of the vehicle in real time via the internet.

If your teen driver is lost you can locate your vehicle in real time and give directions by phone to come home safely. You can locate your vehicle via the internet and make sure your kids are safe.

### Geographic Zones

Pre-set safety zones (bordered geographical areas) where one feels comfortable letting the teen drive can be controlled. Areas may include your neighborhood, the route to school, the closest mall or to and from the homes of friends and family. If the vehicle exits an activated safety zone an email or text message alert is received. If the driver exceeds a pre-set speed limit, an email or text message alert is received.

One can locate and track a lost or stolen vehicle and give police the vehicle's exact coordinates so that it can be recovered. If keys are locked inside a vehicle, the door can be remotely unlocked.

A detailed history of the asset's activities is maintained. The report and the reporting intervals desired are chosen to produce clear, easy-to-use information. Report types include location history. Automatic alerts keep the owner informed in real-time of a family's safety. Alert setup allows easy specify parameters, and one can choose which activities will trigger alerts. The alerts are user configurable, specified in the initial program setup, and may be changed at any time. One or more recipients can be selected for alerts and delivery by email or text message. Alerts can be generated whenever a vehicle enters a restricted area or leaves the perimeter of a location or boundary which has been specified. If the vehicle travels at a speed higher than a specified limit, an alert is received. Whenever movement is shown for the vehicle, but the ignition is off, an alert is received. An alert can be generated whenever the ignition is turned.

### Security

The present platform can be used to secure assets by connecting with digital surveillance, and high-speed full motion video. Enabling real-time data for security applications including alarm panels, intelligent locks, asset monitoring devices and the latest in high-speed video capture and transmission, security is delivered by use of the present system. With simple integrated devices and a host of embedded platforms, companies of all sizes with resilient, are empowered with high-speed, scalable, and reliable end-point security and asset monitoring connectivity solutions. The present system offers a flexible, modular architecture for fast wireless connectivity and solutions deployment. Mission-critical infrastructures can be efficiently managed and high-value assets can be located and leveraged using real-time location services. Devices can be provisioned, monitored and reconfigured remotely, most anywhere in the world.

Overcall, security can be achieved using the present system. Cutting-edge and multi-purpose diagnostics can provide security with always-on GPS tracking, reporting and analytics. The vehicle tracking devices plugs into the vehicle OBD II port. Its compact design allows easy installation. Its internal OBD reader can obtain information from the vehicle's on-board computer and relay it over the networks. Its built-in GPS receiver has superior sensitivity and fast time to first fix. Its Quad band allows the vehicle's location to be monitored in real time or periodically tracked by a backend server and mobile device. A built-in 3-axis accelerometer can allow motion detection. In one embodiment, the system is an integration of GPS tracking system, RFID vehicle.

Personal identification immobilizer security system & an OBD-II diagnostic system. The system is further backed by an integrated system that is straight forward to use. The application supports a wide variety of reports including emergency, geo-fence boundary crossings, low battery and scheduled maintenance and GPS position. The location can be monitored in real time or periodically tracked by a backend server and mobile devices. Its built-in 3-axis accelerometer allows motion detection and extends battery life through sophisticated power management algorithms.

### Data Switch

Every business has a multitude of processes that provide the context for work within the company and among external business units. The efficiency and effectiveness of business process execution can often mean the difference between highly profitable success and costly failure. Business Process Management (BPM) or the automation thereof has emerged as a key discipline to help companies improve their business processes to create a more efficient and cost effective environment.

Data Switch is the discipline of modeling, automating, managing, and optimizing business processes, irrespective of the business applications. A successful Business Process Management initiative, which includes the right mix of business leadership and technology, enables significant reduction in cycle times—sometimes as much as 90%—and of cause costs. This is particularly true for processes inherent in business partners, departments, applications, and users. From a technology perspective, the present data switch system can easily integrate with existing applications, legacy systems—such as CRM, ERP, and ECM—without requiring a general system redesign.

Beyond the time and cost benefits, organizations that will implement the present data switch will also realize several other key benefits. Costly errors, such as forms and documents being lost or misfiled, key information being omitted, mismatching of information or required reviews not occurring, are dramatically reduced or eliminated. Visibility of process activity improves dramatically, with all process participants empowered to understand not only their role in the process, but exactly how the work flows and the tracing and the tracking of the status of each process at any time, monitoring the SLA of each of those processes. With visibility comes true accountability, with complete and open knowledge of what is due and when. Excuses related to delays, misunderstandings, or simple oversights will be drastically reduced. Consistency improves, providing internal and external parties with a clear set of expectations. The end result is increased employee, customer, and partner satisfaction and loyalty.

Provided is a complete software data integration solution. Additionally, a variety of open interfaces (API's) are available to extend and integrate the product into any existing corporate infrastructure. Featuring easily understandable user interfaces, the BPM Suite promotes daily use in process implementation and management for non-technical software users. Customers in a variety of industries can use the suite to support customer care (e.g. custom quote processing, new account setup), product development (e.g. localization, defect solution), administration (e.g. invoice processing, capital equipment requests), human resources (e.g. employee roll-on, merit reviews), and many more areas.

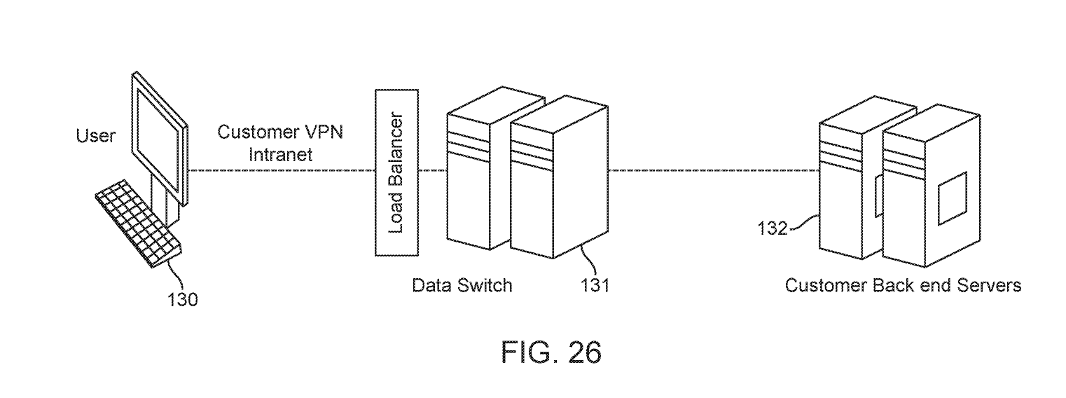

The runtime execution engine for automated processes manages all the incidents or individual cases that are running, for all automated processes. It manages the connections between all of the enterprise applications in the system, including databases, directories, productivity applications, and back office systems. The server has a feature rich administration module that enables user management and system management. The architecture is shown in FIG. 26.

The server has an extensive Data Access Layer (DAL). The advantage of the DAL is that it is centralized, so any changes made to this layer need only to be made in one area.

Changes might happen for optimization, logging data access events, transaction tracing and reporting etc. It is also an integral part of module security as the access to and from the database can only accurse thru this one component namely the (DAL).

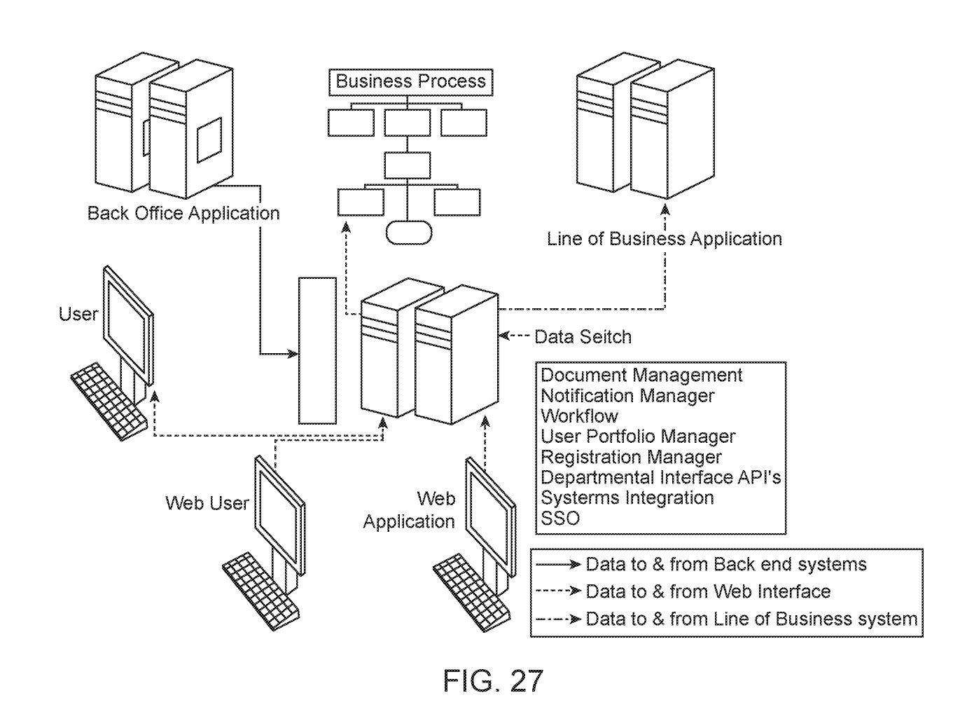

The process designer of the system enables business owners or analysts to graphically design, model, document, and optimize business processes as shown in FIG. 27. Using the process designer, organizations can quickly develop shared knowledge about their business processes, accelerating the time to market for an improved solution.

Provided is a collaborative process design and development environment that is unique in the industry. It combines the features of the process designer, above, with the process development and form designing capabilities in a single unified environment.

IT designers can easily develop forms, conditional routing and other features without any programming or scripting. If more complex development is required, developers can incorporate Web Services, XML, and custom .NET managed Code.

The system also supports developers by allowing them to plug into any editor they choose and manage all components of the system solution development in one place.

A better understanding of the present invention in its varied embodiments will be achieved upon reviewing the figures of the drawing and the various devices and platforms described and shown therein.

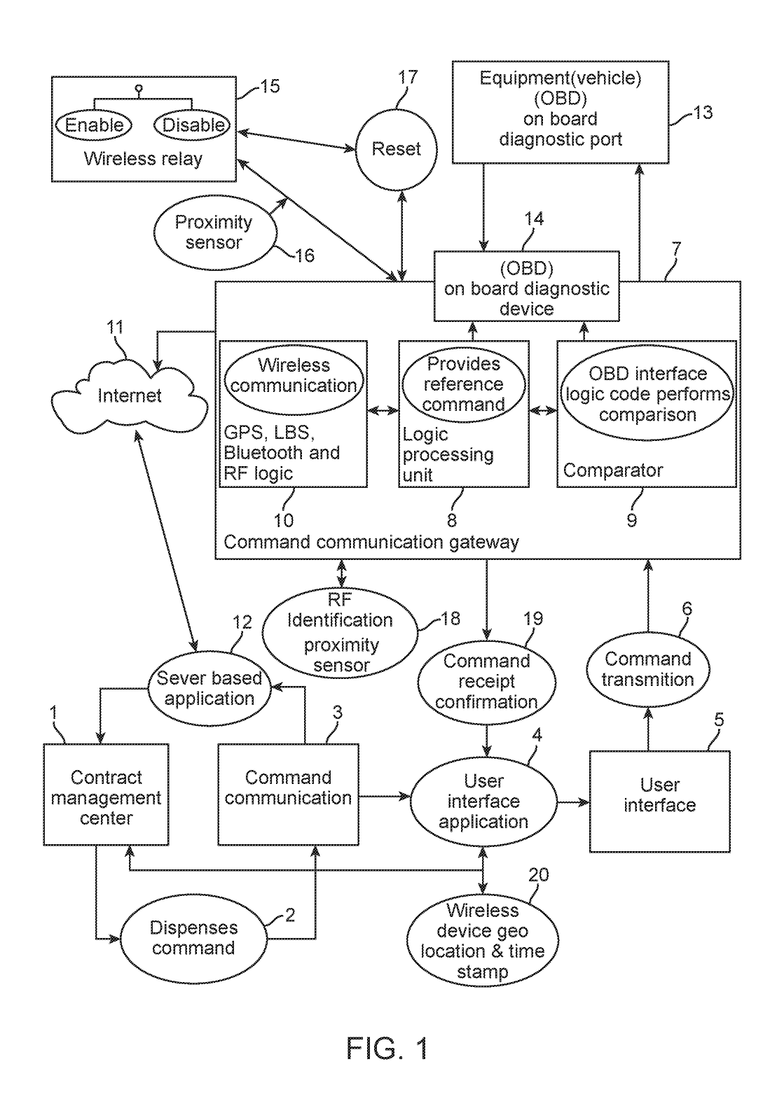

FIG. 1 shows one embodiment of the present invention. The schematic of the figure is an overview of the process of communication and connectivity with a vehicle. It also shows the wireless communication to a central control system.

In the figure is a control management center 1, which can forward a command (or code) with regard to equipment, e.g., to enable, disable, locate, track information, etc. The command is dispensed 2 and goes through a command communication unit 3, which is generally capable of wireless communication. The command is passed through a user interface application 4 to a user interface 5. The user interface can be a keypad, phone, etc. The command code is then transmitted via 6 to the command communication gateway 7.

The logic processing unit 8 provides a reference command/code to the comparator 9. The unit 8 can also provide information via 10 to the cloud 11 for storage. The command/code communication can also be passed from 3 to relay 12, which can forward the command/code for recordation to the cloud 11 and/or to the contract management center 1.

Upon a comparison of the code at 9, information as to agreement or not agreement, and command execution is passed from the gateway 7 to the Diagnostic port 13 on the vehicle, which passes the information to On Board Diagnostic Device 14. The verified command is then passed to the relay 15 which can enable or disable the equipment based on the command from the contract management center 1. A proximity sensor 16 can confirm that the on board diagnostic device 14 is sufficiently close to the relay 15 to ensure the command is received. If a reset is needed, the command can be forwarded through 17 back to the gateway 7. A proximity sensor 18 for RF identification can also be used to ensure appropriate communication.

Often a client or user wants a receipt or confirmation that the command was received and acted upon. The gateway 7 can provide the command receipt/confirmation 19 to the user interface 4, as well as back to the contract management center 1. The information can also include information such as the geographical location, time, next event, etc.

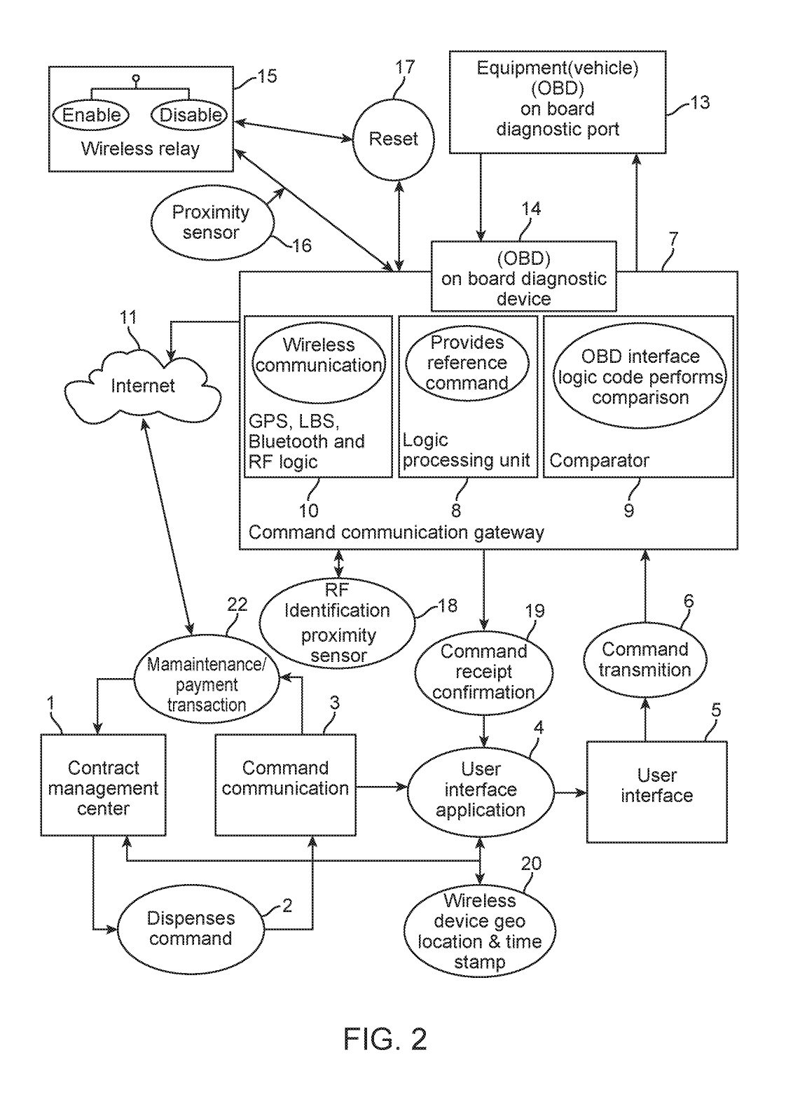

FIG. 2 is a schematic drawing of a wireless appliance to an embodiment of the present invention featuring an integrated maintenance/payment enforcement scheme linked to the contract management center 1. The numerals in FIG. 2 that are the same as in FIG. 1 refer to the same units and flow of information as described in accordance with FIG. 1. The only difference is that 22 states that the application is specifically for the application of a maintenance/payment transaction. Thus, the enable/disable command controlled by 15 would be a control of the equipment or car. The command is often in such a case an enable or disable command. Although other types of enforcement commands and information regarding the equipment can be transmitted through the command communication gateway.

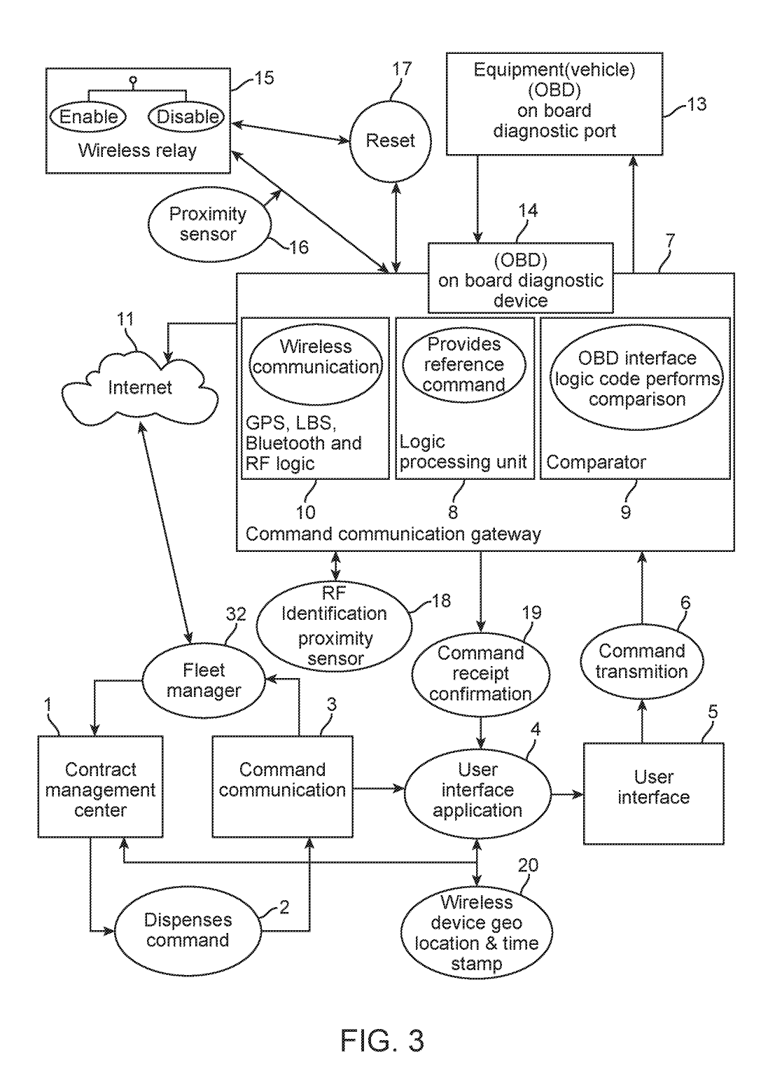

FIG. 3 is a schematic of an embodiment where a wireless appliance features the integration of a fleet management system to a contract. The numerals in FIG. 3 that are the same as in FIG. 1 refer to the same units and flow of information as described in accordance with FIG. 1. The only difference in the two systems is that 32 states the application is specifically for the application of managing a fleet of equipment/vehicles. While the control by 15 of enabling or disabling a vehicle might be used, the system could also be used to locate and track a vehicle in the fleet, and obtain information regarding the geographic location and status of the fleet vehicles as sent via wireless relay to the diagnostic device 14.

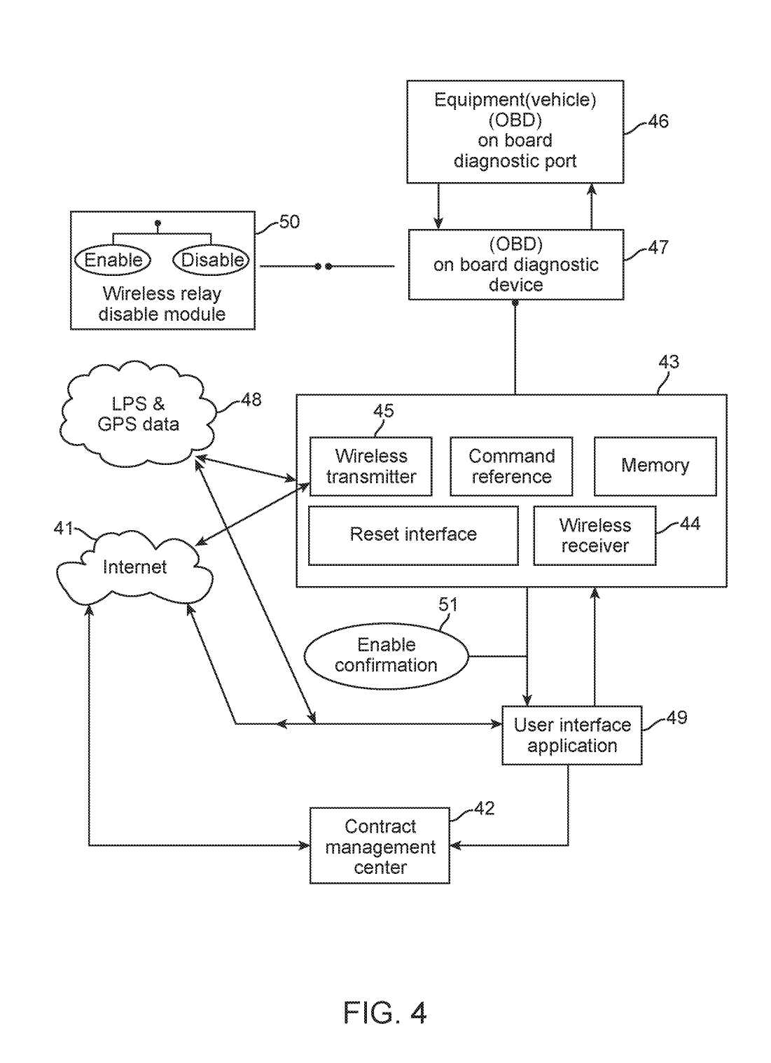

FIG. 4 is a schematic of a wireless relay embodiment featuring an integrated back office management communication flow. Through the internet 41 and wireless communication, information and/or commands can be exchanged between a management center 42 and an equipment communication gateway 43. The gateway can include a wireless receiver 44 as well as a wireless transmitter 45. The gateway is connected to the diagnostic part 46 and diagnostic device 47. Information such as GPS data, tracking information, system operations, etc. can be stored in the cloud 48 as well as forwarded through a user interface 49 to the management center 42. The on board diagnostic device 47 can receive commands and/or forward commands to a disable/enable module 50. Confirmation of the command execution can be returned via 51 and the user interface to the management center.

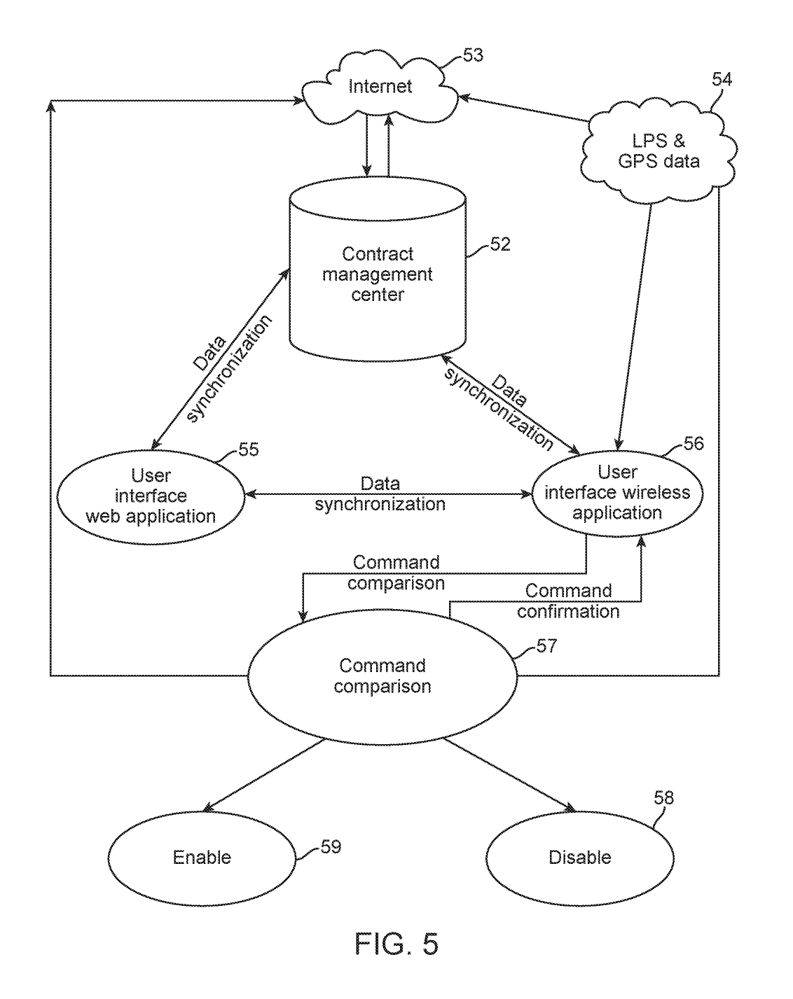

FIG. 5 is a schematic of another embodiment of the present invention relating to enablement and disablement of equipment such as a vehicle. The contract management center 52 can store or recall information through the internet, wireless communication 53. Strategic information can be forwarded from the cloud 54. The data and information can then be synchronized with a user interface web application 55 and a user interface wireless application 56. Commands/codes can be sent from the wireless user interface 56 to a command comparison unit 57. Command confirmation can be returned to the wireless interface 56. Based upon the results of the command/code comparison 57, the equipment or vehicle can be disabled 58 or enabled 59.

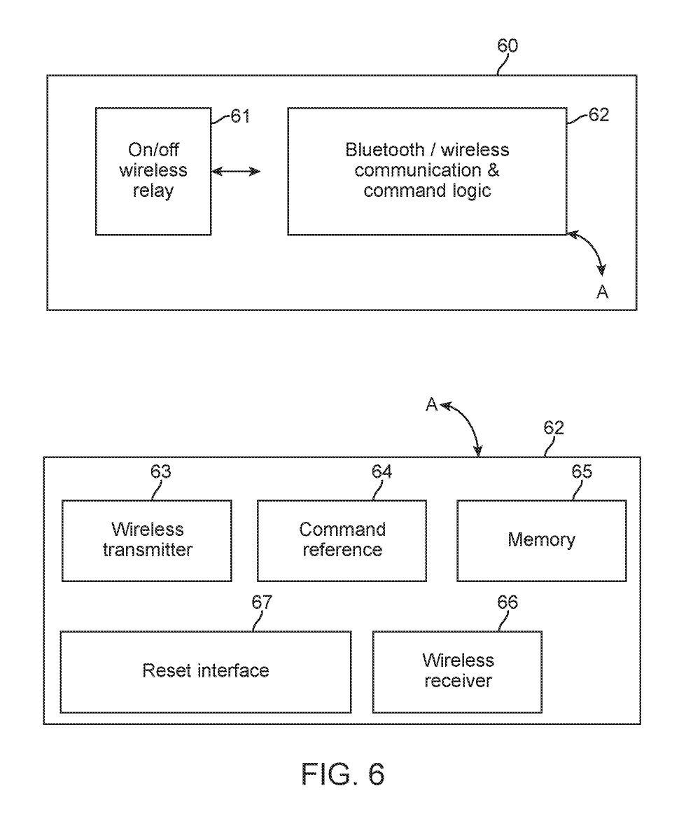

FIG. 6 is a schematic of possible processing units within the equipment or vehicle. The unit 60 can contain a wireless on/off relay 61 as well as a wireless communication and command logic unit 62. The unit 62 can comprise, for example, a wireless transmitter 63, a command reference unit 64, memory storage 65, a wireless receiver 66 and a reset interface 67.

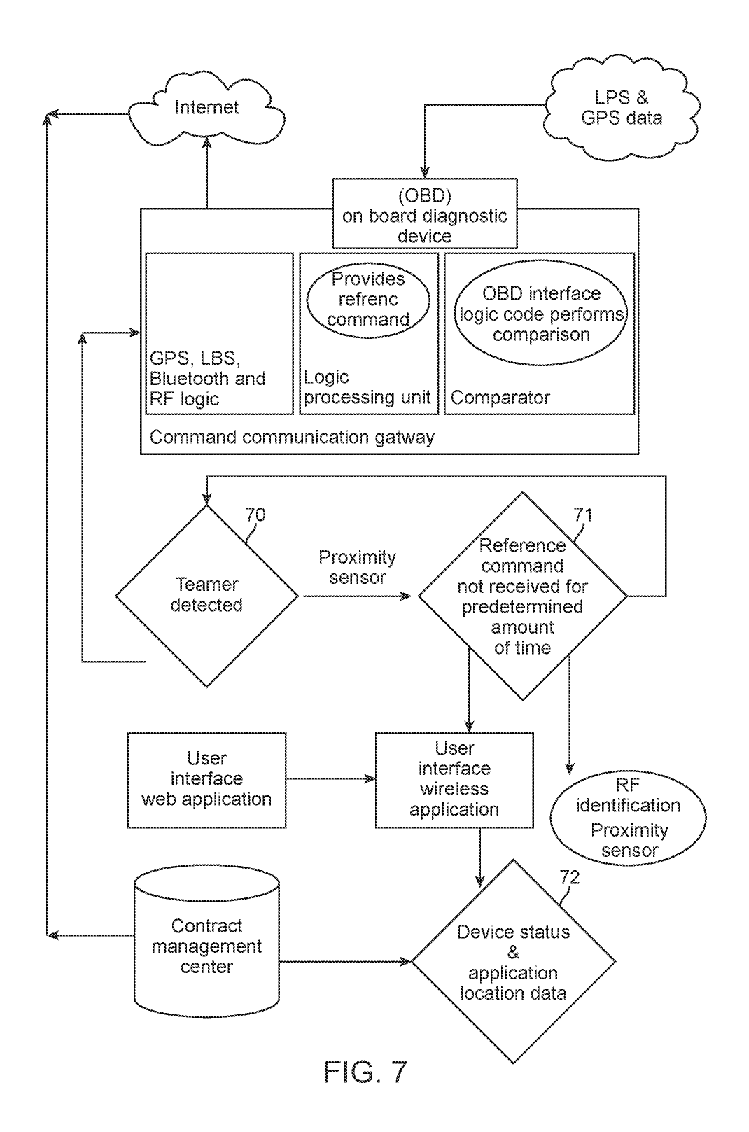

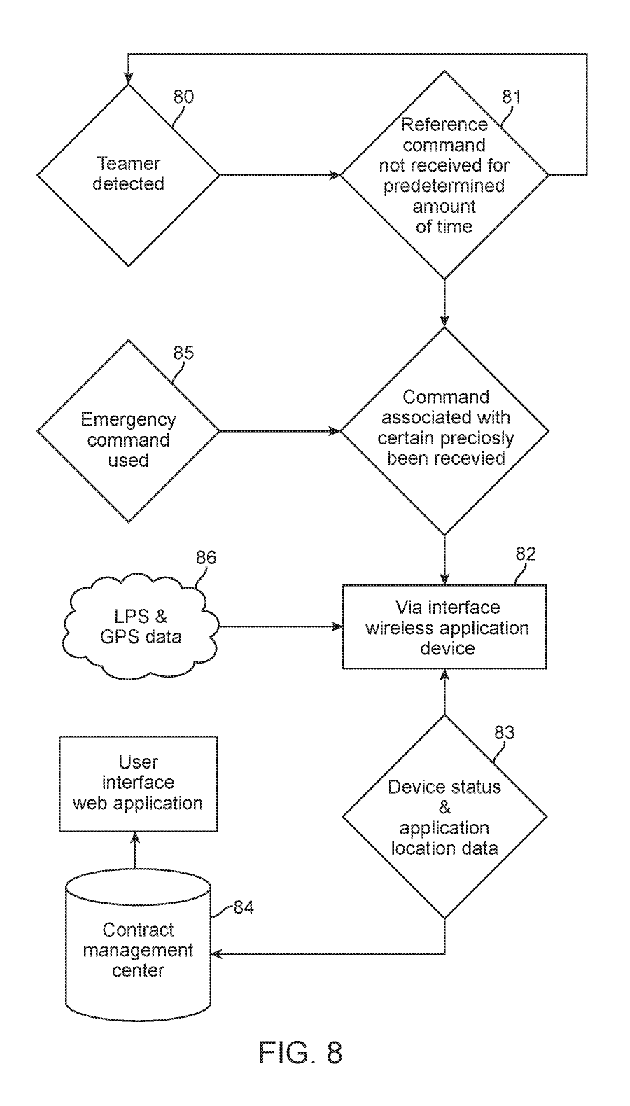

A schematic of a scheme for reporting loss of communication within the components of a system, due to tampering or loss of power, is shown in FIG. 7. When tampering to the system is detected 70, or a reference command sent at predetermined intervals is not received due to tampering or loss of power 71, a notice/warning can be forwarded to a unit recording and monitoring the system status 72. This is shown more clearly in FIG. 8. When tampering is detected 80 and/or a predetermined reference command is not received 81, the alert can be forwarded through a wireless interface 82 to the unit 83 monitoring system status. This information can also be forwarded to the management center 84. An emergency command or alert 85 can also be initiated and forwarded through the wireless interface 82 to the unit 83 monitoring status and the management center 84. Additional information can also be retrieved from the cloud 86.

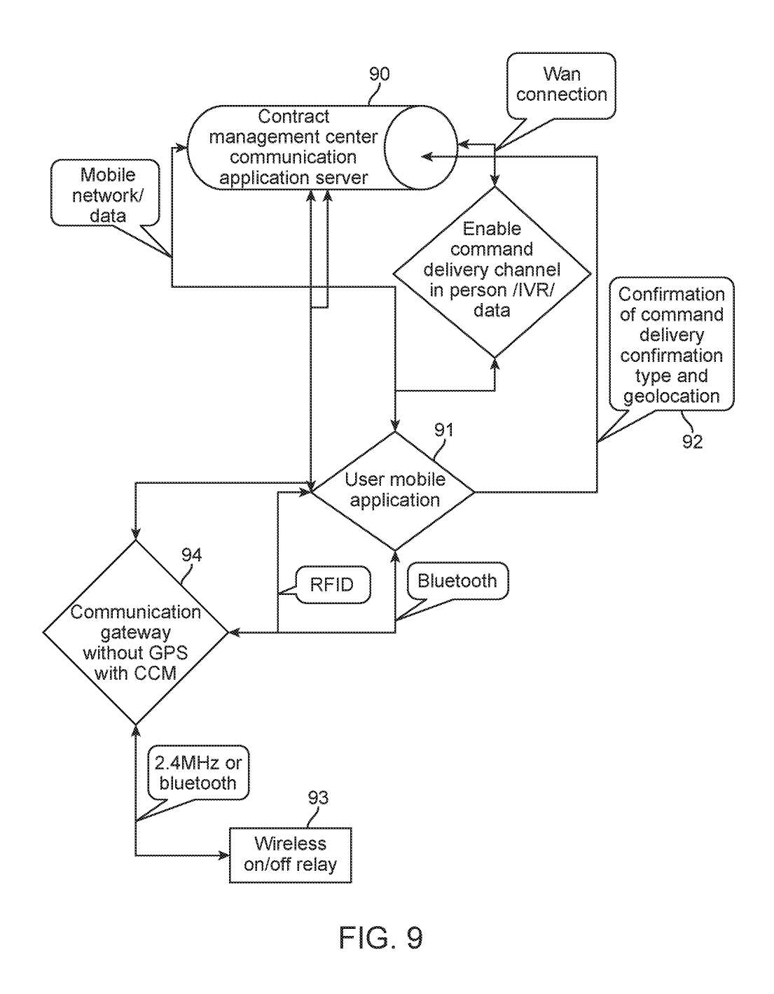

FIG. 9 portrays an embodiment in which a disablement or enablement confirmation is reported to the management center. The management center 90 receives the communication via the user mobile application. The communication can be a confirmation of the command delivery and confirmation of the action. The communication can also involve additional information such as geographical location 92. The wireless on/off relay 93, which controls the enable/disable action, forwards the report to the communication gateway 94, which then forwards the report and information through the user mobile application to the management center 90, or directly to the management center 90.

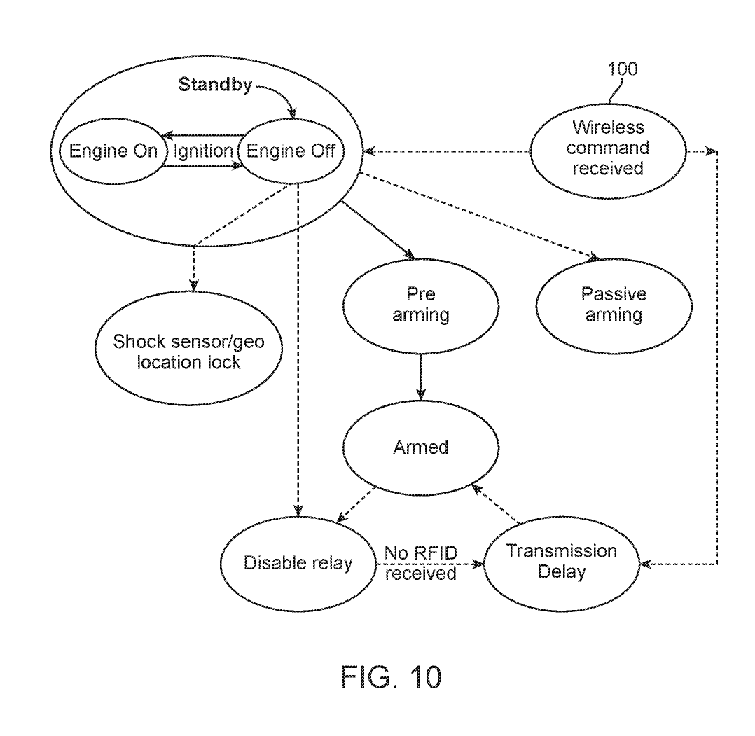

A security logic system is schematically displayed in FIG. 10. The system can be used to manage a preauthorized identification system which is linked to a user list. The driving profiles of the users have been predefined and stored within the system. The wireless command 100 can turn the engine off or on, based on the user identification confirmation.

FIG. 11 is a schematic drawing of the processing of data from a unit and processing the information via a multi communication channel that is user defined in the case of Bluetooth connectivity with a mobile device 101 with a mobile application, the data is sent to the mobile device that will transmit to the management center (A). FIG. 11 also shows the processing of data from a unit and processing the information via a multi communication channel that is user defined in the case of there being no Bluetooth connectivity with a mobile device with a mobile application. The wireless transmitter within the appliance will start a data communication and send the relevant data to the management center (B).

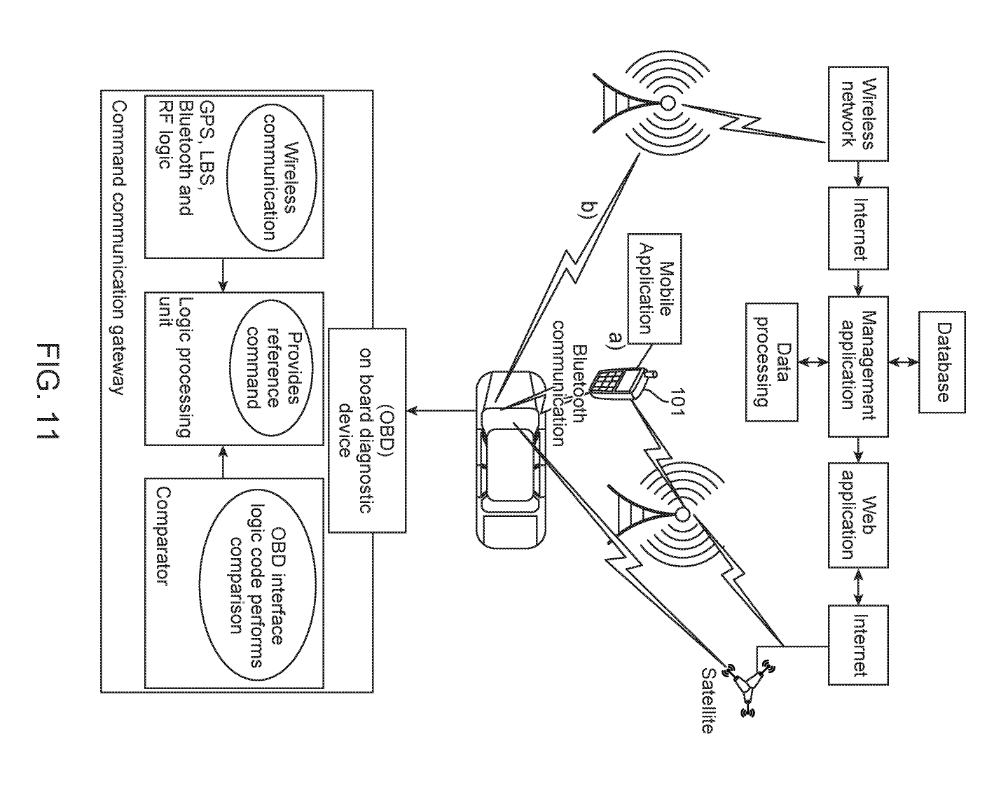

FIG. 12 is a schematic of processing units that can initiate a disable/enable command upon a wireless command from a management center 120 forwarded to the equipment/vehicle diagnostic port 121. The command can also be generated upon a tampering of equipment or unauthorized use. The command to the diagnostic port can be relayed by a vehicle communication system 122, a GPS/GSM system 123, and RFID or Bluetooth communication system 124, or a microprocessor 125.

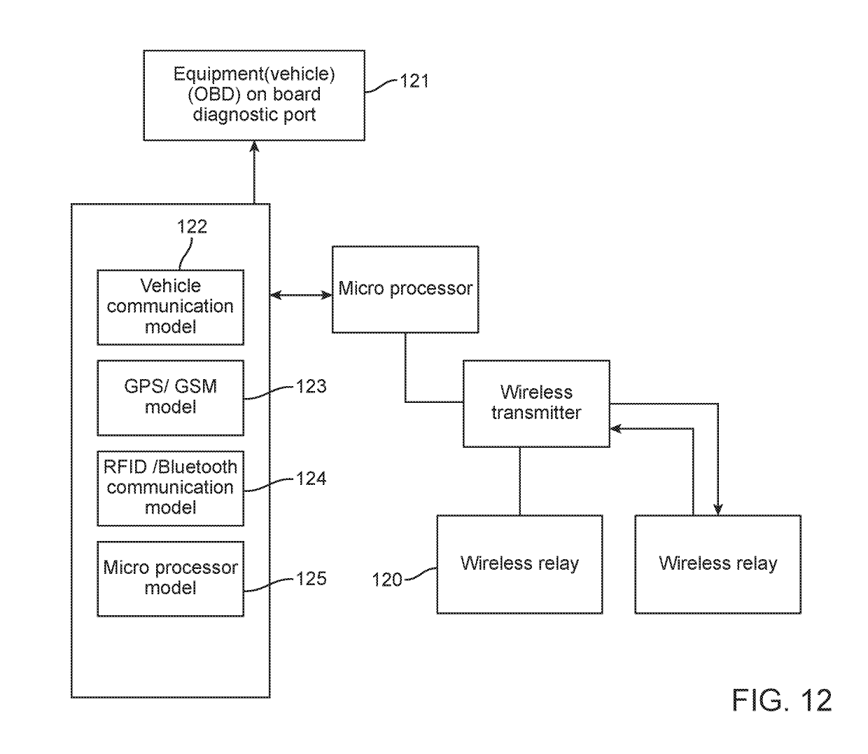

FIG. 13 is a schematic of an embodiment of the invention featuring integrated antennae and custom ASICs 130 for power management 131, OBD communication 132, GPS 133, and wireless transmission 134.

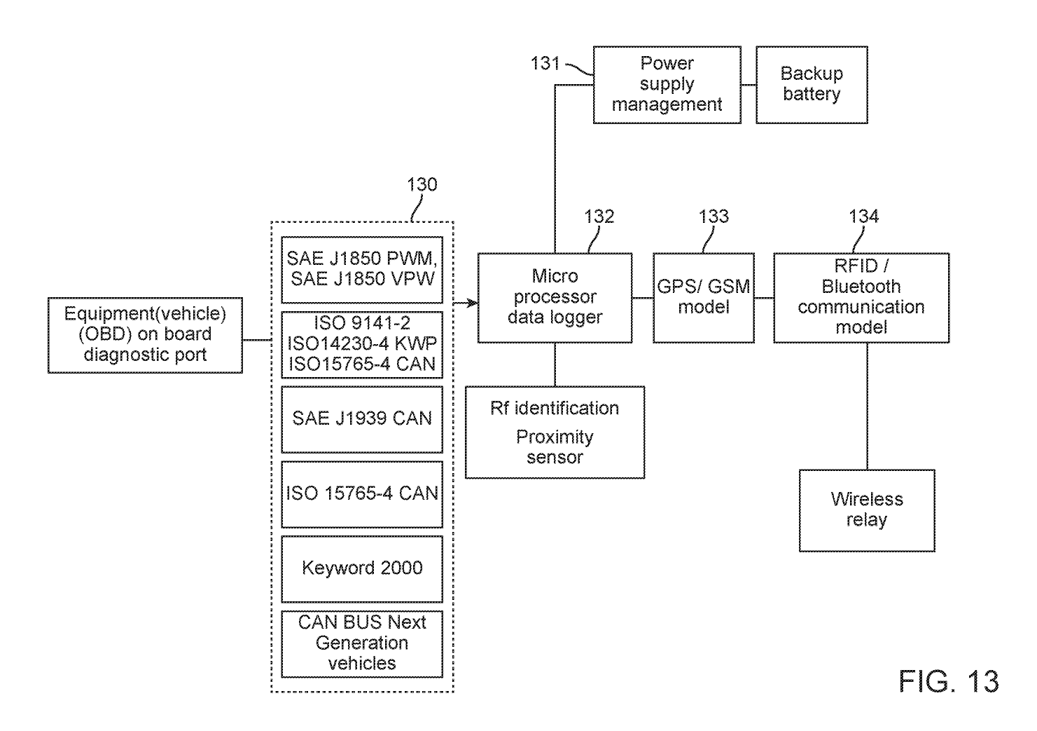

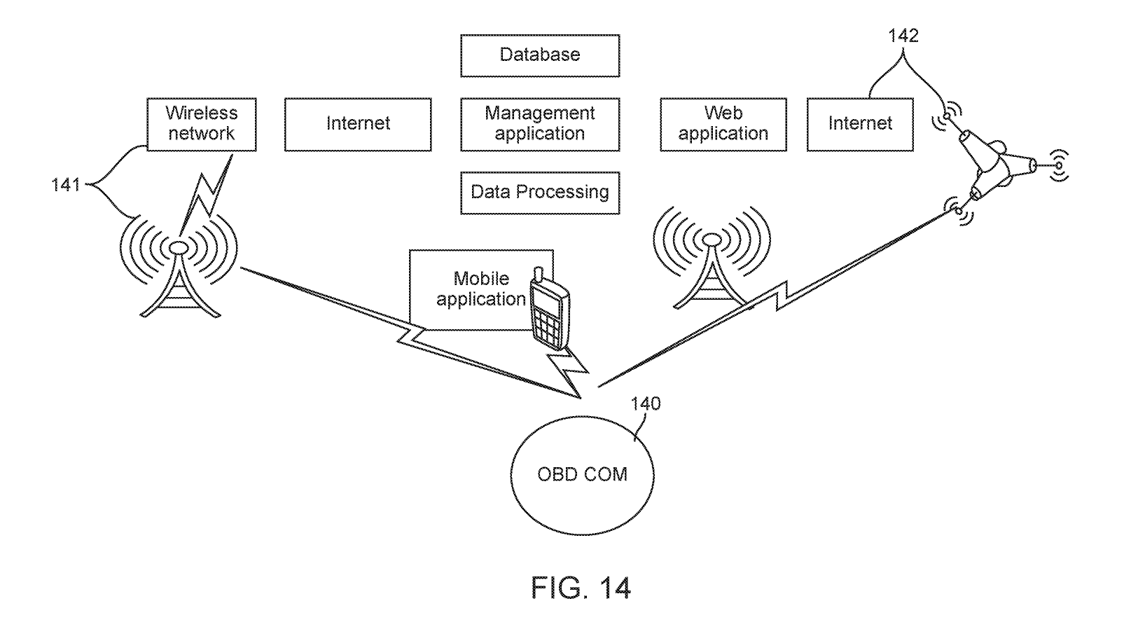

FIG. 14 is a schematic of a vehicle system 140 that can communicate with GPS, but also a wireless communication network 141 and an internet accessible network 142.

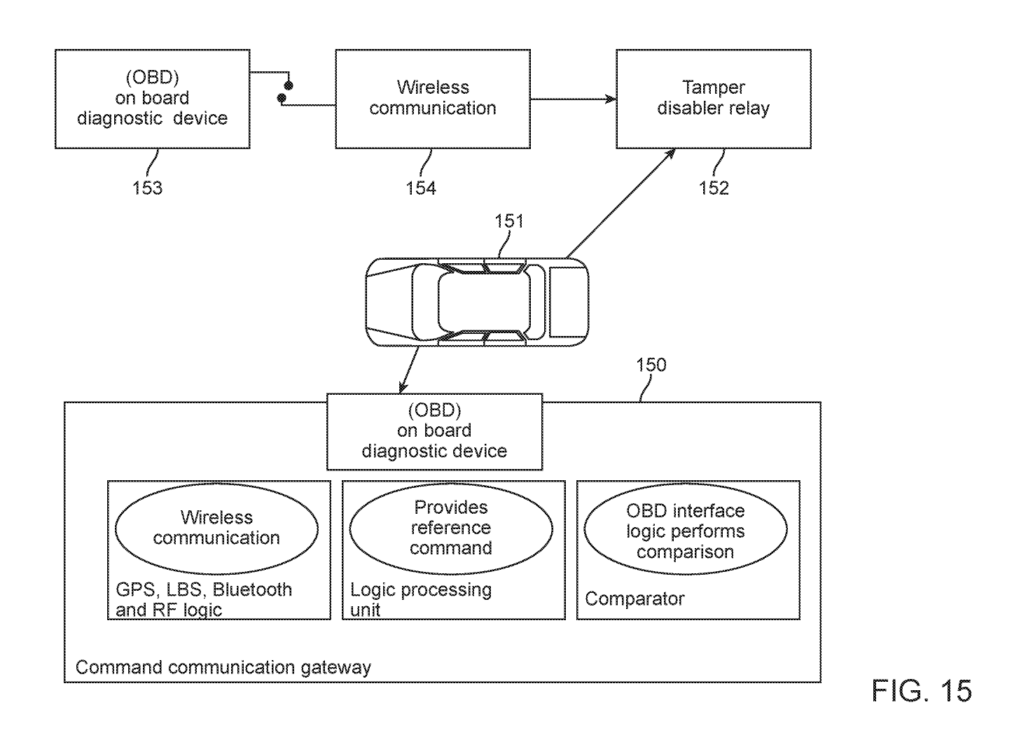

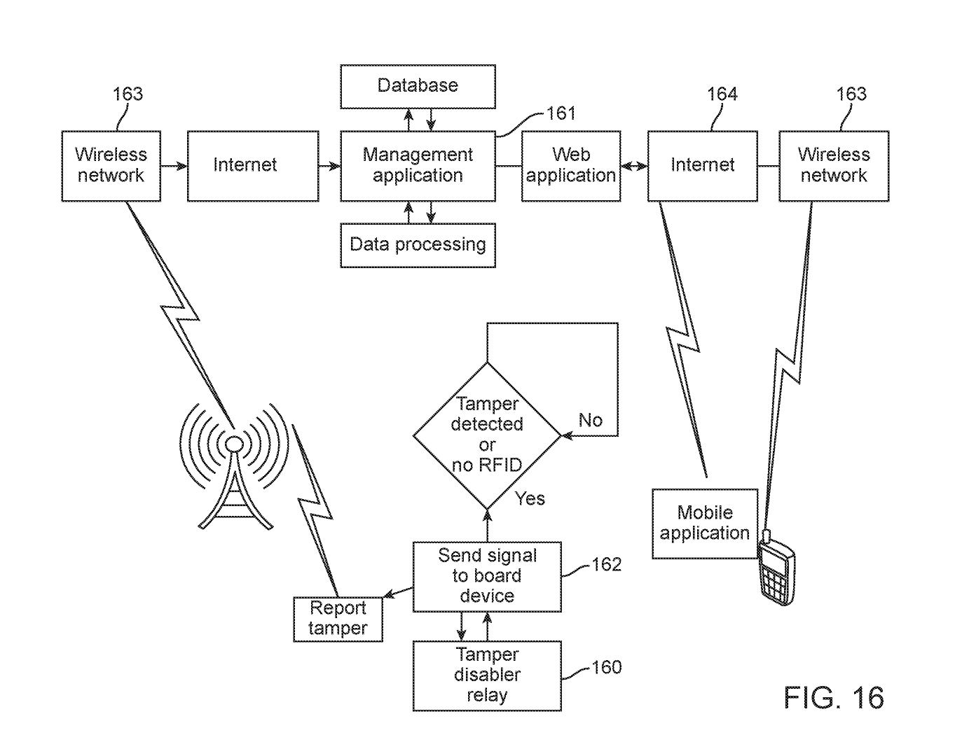

FIG. 15 shows a schematic drawing of a processing unit 150 on a vehicle 151 that communicates with a tamper disabler system 152. The on board diagnostic device 153 can communicate via wireless communication 154 with the tamper disabler system 152. The tamper disabler system can disable the vehicle once tampering is detected. FIG. 16 further shows the communication of the tamper disabler relay 160 in reporting the tampering to the control center 161. The report can go through the on board device 162 via wireless communication 163 or the internet web 164.

FIG. 17 provides an overview of various possible processing units and means of communication with a control center or management center.

FIG. 18 shows a screen capture of a possible web page. The web page displays a vehicle's diagnostic data as monitored. The monitored information is communicated by a wireless communication. FIG. 19 shows two other screen captures of possible displays. One displays the diagnostic data of the equipment or vehicle as monitored. The data includes possible driver data. The information is communicated by wireless communication. The other screen capture displays vehicle information that relates to commands used for managing a vehicle, including enable/disable commands.

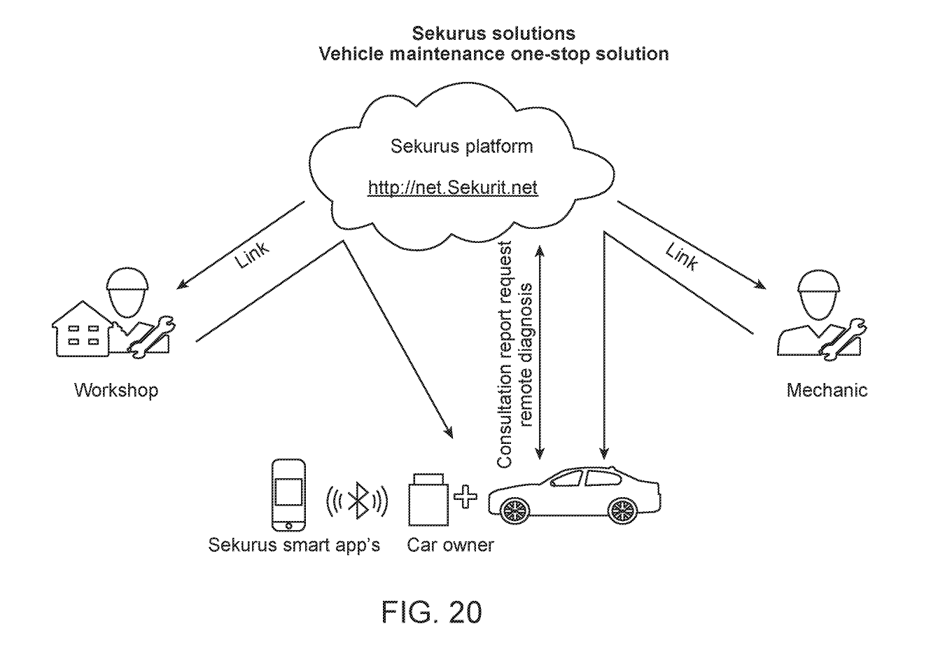

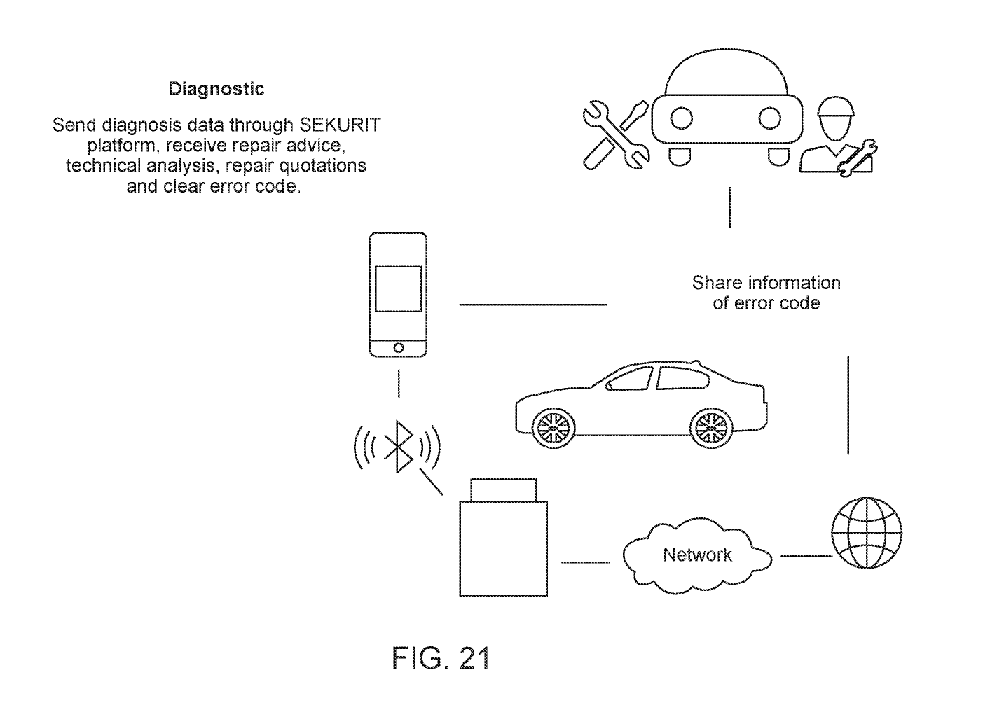

FIG. 20 is a schematic showing how the present system can be used as a vehicle maintenance one-stop solution. Through a web platform, links and communication with workshops and mechanics can be had, which allow diagnosis and maintenance to proceed and be completed. FIG. 21 also schematically displays how the present system can make the diagnosis and repair of a vehicle more efficient by the sharing of information through a web platform.

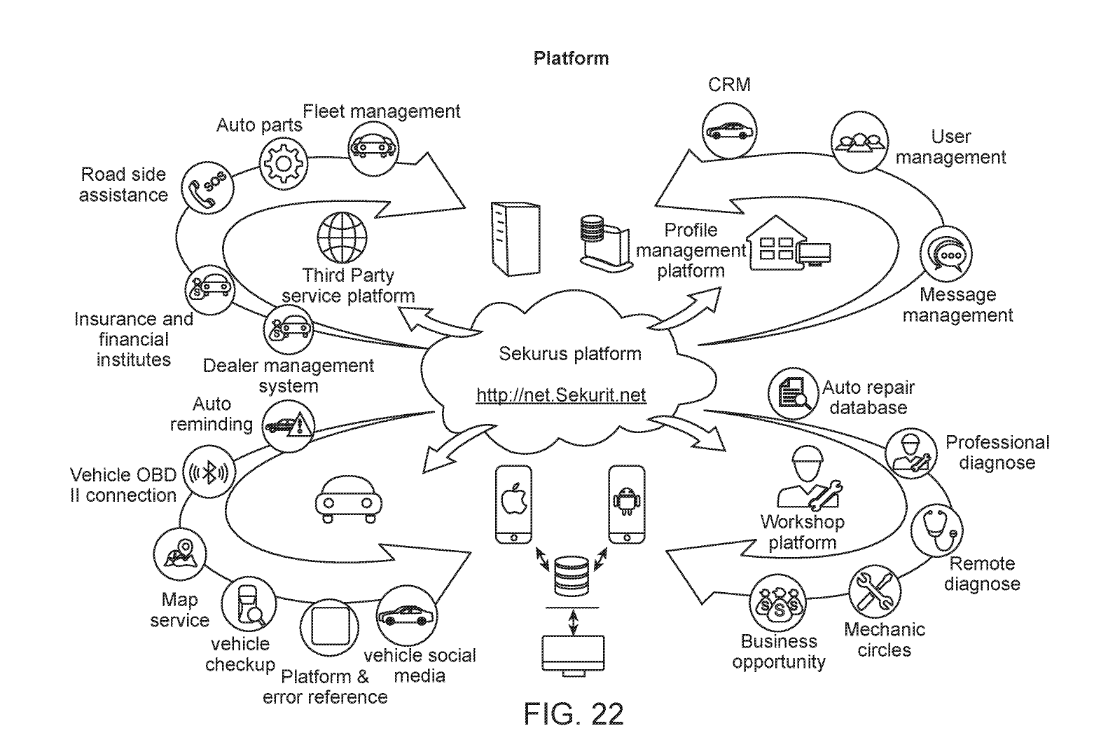

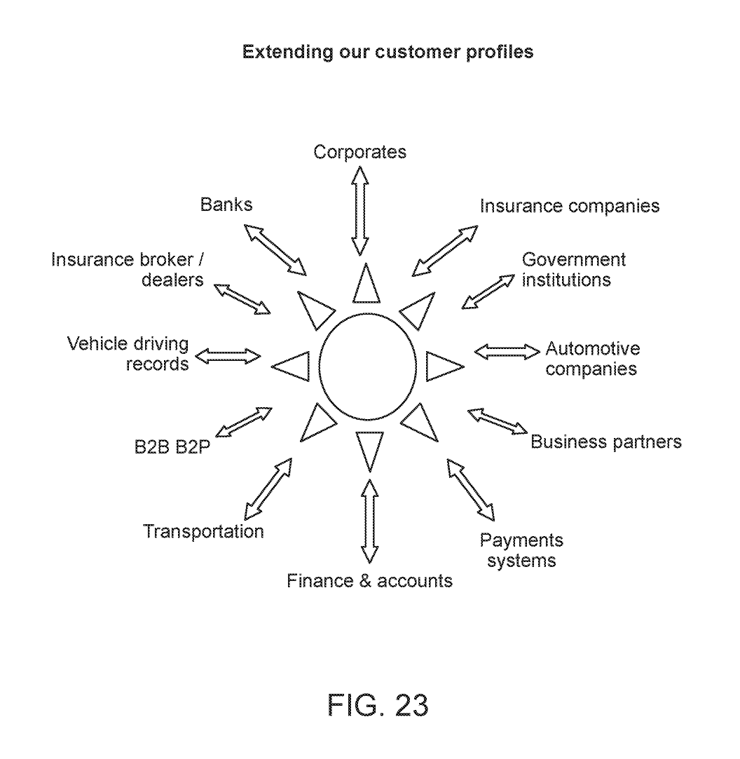

In FIG. 22, benefits for the providers as well as the customer when using a platform in accordance with the present invention are schematically displayed. A third party service platform can aid in monitoring appropriate management of a vehicle. The workshop platform can monitor appropriate care of a vehicle by the provider, but also aid a user in meeting the obligations of care. FIG. 23 illustrates the various ways the platform offered can benefit the customer. The customer profile can be extended through the use of the platform as information can be saved and recalled.

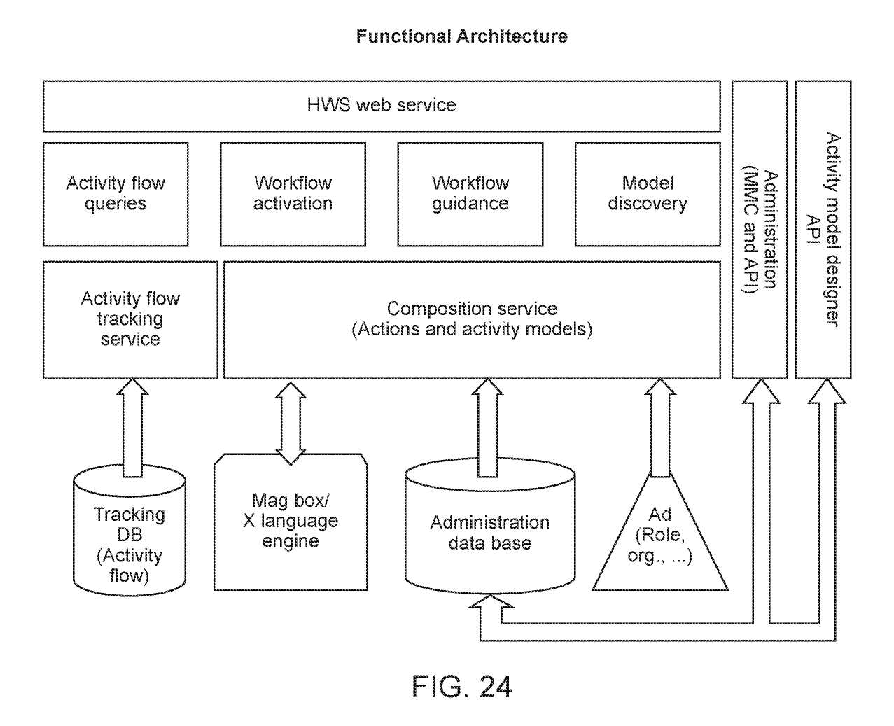

FIG. 24 depicts the functional architecture possible when using the present system. Activity, workflow, and administration can all be tracked, controlled and administered.

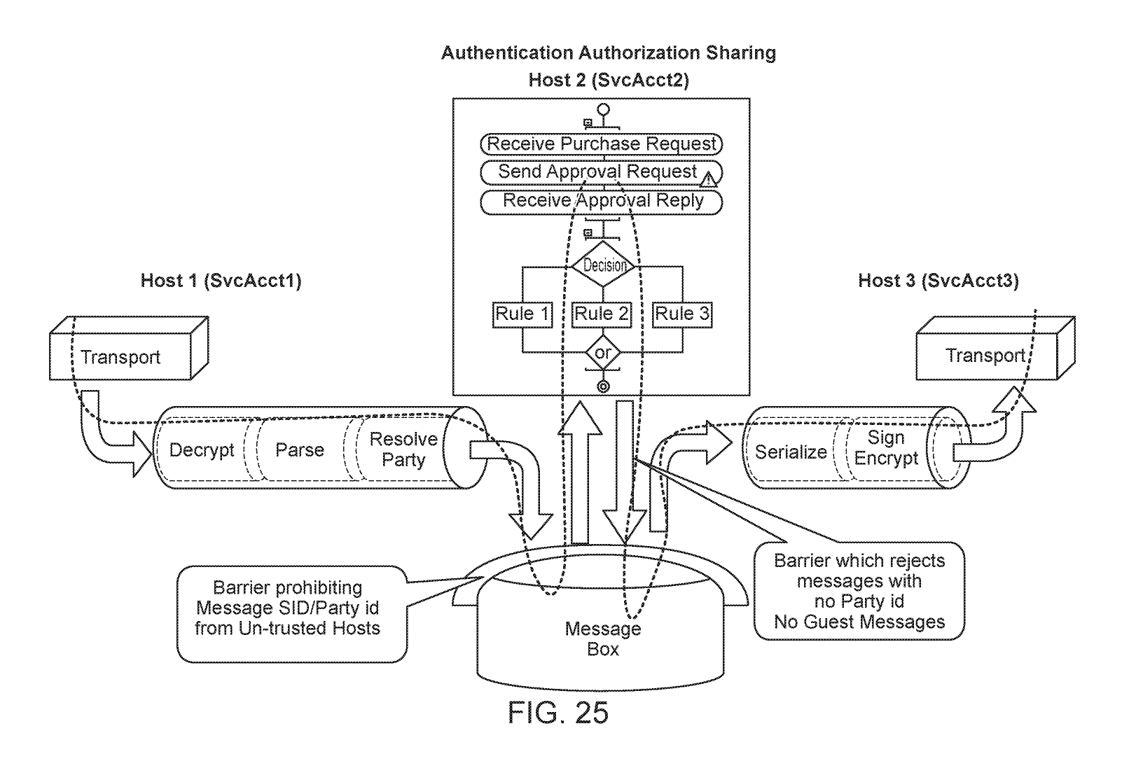

FIG. 25 depicts the benefits of sharing information regarding authentication authorization. The sharing of information for the provider can expedite the process, which also benefits the user/customer.

FIG. 26 illustrates the feature rich administration module comprising a user interface 170, a data switch 171 and customer back end servers 172. The module enables user management and system management. The module can manage all the connections between all of the enterprise applications in the system, including data bases, directories, productivity applications and back office systems. FIG. 27 illustrates the process design of the system connecting the user with the available information.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

What is claimed is:

1. A process for making a payment on a car loan by a user comprising
a. releasing a command to the user upon payment;
b. the user operates a user-operator interface connected to a logic processing unit to convey the command to the logic processing unit; and
c. the logic processing unit verifies the command and manipulates the automobile starter circuit to enable the vehicle.

2. The process of claim 1, wherein the command is also released to the user upon performing scheduled maintenance.

3. An apparatus comprising
a. a critical system interruption circuit operable for enabling and disabling a critical system of equipment;
b. a logic processing unit having a reference command generation and storage facility, and a comparator; and,
c. a user interface operable for receiving a command from a user and conveying that command to the logic processing unit.

4. The apparatus of claim 3, wherein the apparatus further comprises a system memory into which are loaded loan terms, maintenance dates and driving distances.

5. The apparatus of claim 4, wherein the critical system interruption circuit disables a critical system of the equipment if a predetermined command is not received prior to a pending loan term, maintenance date or driving distance.

6. The apparatus of claim 3, further comprising a system that forwards a confirmation code to the user when a maintenance date is met.

7. The apparatus of claim 6, wherein the confirmation code can be sent to the user interface via wireless communication, and receipt of the command results in the central system interruption circuit enabling the equipment.

8. The apparatus of claim 3, wherein the apparatus is installed in a car.

9. The apparatus of claim 3, wherein the apparatus is an appliance.

10. The apparatus of claim 8, wherein the apparatus comprises a memory system which records information relating to the driving of the car, which information in the memory system can be accessed by an authorized user.
